(19) United States
(12) Patent Application Publication
(10) Pub. No.: US 2011/0000622 A1
(43) Pub. Date: Jan. 6, 2011

(54) HAND-HELD DEVICE FOR APPLYING A CORRECTION MATERIAL ONTO A SURFACE

(75) Inventors: Franck Rolion, Beloy en France (FR); Baudouin Bertrand, Paris (FR)

Correspondence Address: JONES DAY, 222 EAST 41ST ST, NEW YORK, NY, 10017, US

(73) Assignee: Societe BIC, Clichy (FR)

(21) Appl. No.: 12/808,103

(22) PCT Filed: Nov. 25, 2008
(86) PCT No.: PCT/EP2008/009988

§ 371 Date: Jul. 28, 2010

(30) Foreign Application Priority Data
Dec. 14, 2007 (EP) 07123237.5

(51) Int. Cl. B32B 37/00

(52) U.S. Cl. 156/538

(57) ABSTRACT

A hand-held correction tape device for transferring a deposit of for example adhesive, covering or colored material onto a surface, the device having a housing for accommodating a deposit, a supply reel and a tip longitudinally projecting from the housing with the deposit extending from the supply at the lower longitudinal side of the tip facing the correction surface during operation. A front tip portion of the tip runs transversely at the front end, the rotation plane of the deposit supply reel being parallel to the front tip portion, and the tip includes at least one guiding wing that is partially curved and attached to the front tip portion.

### CROSS-REFERENCE TO RELATED APPLICATIONS

This application is a national stage application of International Application No. PCT/EP2008/00988, filed on Nov. 25, 2008, which claims priority to European Patent Application No. 07 123 237.5 filed on Dec. 14, 2007, the entire contents of both applications being incorporated herein by reference.

### BACKGROUND OF THE INVENTION

1. Field of the Invention

The embodiments of the present invention relate to a hand-held correction tape device.

2. Background of the Invention

A hand-held device of this type is described in publication EP 1 295 834 A1 (“the '834 application”). In the '834 application, the hand-held device includes an application member that has at least two application member portions moveable in relation to each other, and motion stops that correspond to each other are arranged at the application member portions, the stops bordering the relative movement between the application member portions.

It is an object of the present invention to improve a hand-held device with respect to how its movement is carried out and/or to design a hand-held device such that it can be manufactured easily and inexpensively. In doing so, a small construction is ensured as well.

### SUMMARY OF THE INVENTION

The present invention relates to a hand-held device for transferring a deposit of for example adhesive, covering or colored material onto a correction surface, the device having a housing accommodating a deposit supply reel and a tip longitudinally projecting from the housing with the deposit extending from the supply at the lower longitudinal side of the tip facing the correction surface during the mode of operation to a front tip portion of the tip running transversely at the front end, the rotation plane of the deposit supply reel being parallel to the front tip portion, and the tip comprising at least one guiding wing. Preferably the at least one guiding wing is partially curved and the partially curved guiding wing is attached to the front tip portion.

Preferably, the front tip portion is further attached to a central application gib extending along the tip.

Further, preferably a lateral guiding wing is laterally attached to the central application gib.

Preferably, the lateral guiding wing is a cuboid protruding the top and the bottom of the central application gib.

In a preferred embodiment the partially curved guiding wing extends from the lateral guiding wing to the front tip portion.

Preferably, the partially curved guiding wing is a band having a substantially circular cross-section.

Further, preferably, the partially curved guiding wing comprises a first straight part being attached to the lateral guiding wing.

Preferably, the partially curved guiding wing comprises a curved part extending from the first straight part to the front tip portion.

Alternatively, the partially curved guiding wing comprises a curved part attached to the first straight part and to a second straight part, the second straight part extending to the front tip portion.

In a preferred embodiment the partially curved guiding wing is provided on the upper longitudinal side being opposite the lower longitudinal side.

Preferably, on each side of the central application gib a partially curved guiding wing and a lateral guiding wing is provided.

### BRIEF DESCRIPTION OF THE DRAWINGS

In the following, preferred configurations of several preferred embodiments will be explained in more detail in relation to the drawings.

FIG. 1 is a side view of a hand-held device known in the art for transferring and/or applying a deposit of, for example, adhesive, covering or colored material onto a correction surface;

FIG. 2 is an exploded view of a hand-held device known in the art;

FIG. 3 is an exploded view of a detail of the hand-held device as shown in FIG. 2a;

FIG. 4 is a perspective top view of a tip according to an embodiment of the present invention;

FIG. 5 is a perspective bottom view of a tip according to an embodiment of the present invention;

FIG. 6 is a side view of a tip according to an embodiment of the present invention;

FIG. 7 is a top view of a tip according to an embodiment of the present invention; and

FIG. 8 is bottom view of a tip according to an embodiment of the present invention.

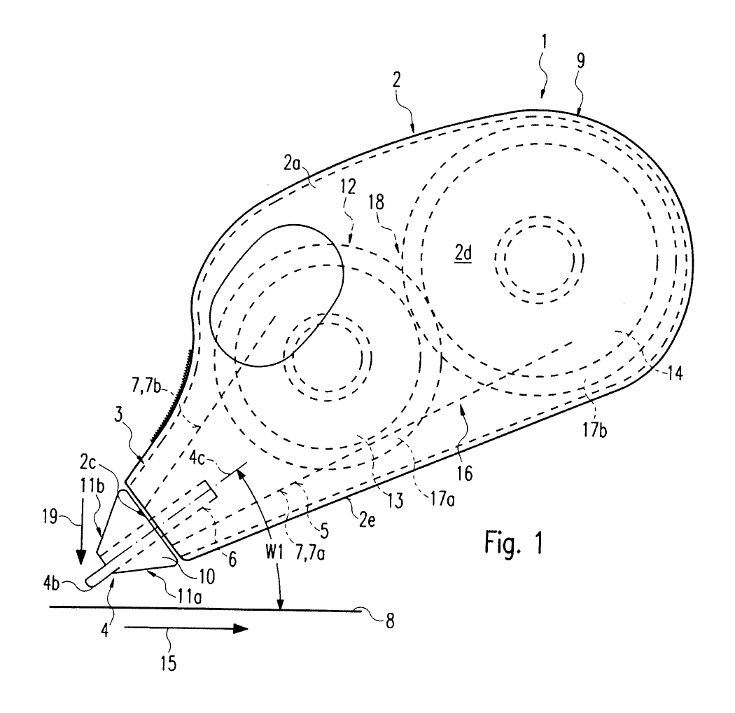

With regard to the embodiments of the device shown in FIGS. 1, 2, 3 in which the rotational plane of the deposit supply reel is arranged orthogonal to the tip portion of the device, it is to be noted that these embodiments do not form part of the invention but represent background art useful for understanding the invention.

With respect to FIG. 1 the principle of a hand-held device for transferring and/or applying a deposit of for example adhesive, covering or colored material onto a substrate will be explained in the following.

The hand-held device 1 comprises a housing 2 that includes at least two longitudinally transversely divided housing parts, namely an upper body 2a and a lower body 2b which can be mounted to each other in a detachable or non-detachable fashion. FIG. 1 shows a hand-held device 1 in its position of operation. The left-hand and lower end of the housing 2 or the hand-held device 1 in FIG. 1 is its working end 3 at which a tip 4 is provided, which projects from the circumference of the housing 2 with a central application gib 4a. The central application gib 4a extends in a preferably wedge-shaped convergent fashion towards an application edge 4b, which can be rounded, if necessary. The tip 4 is associated with an application base 6, the application base 6 being mounted into the housing 2 in a detachable fashion in the preferred embodiment.

The hand-held device 1 transfers a deposit 5 of covering and/or colored and/or adhesive material from a support paper 7 onto a correction surface 8, for instance, a sheet of paper. The support paper 7, which preferable extends from a supply located in the cavity of the housing 2 towards the tip 4 in the area of at least one tip opening 2c, is wound around its application edge 4b and is preferably refed to the cavity of the housing 2 through the tip opening 2c. The backing tape section approaching the central application gib 4a at the lower longitudinal or approach side 11a of the tip 4 is identified by 7a. The backing tape section being refed into the housing 2 at the upper longitudinal or return side 11b of the tip 4 is identified by 7b. The winding plane W1 extends roughly in parallel and preferably mid centrally to the sides 2d of the housing 2, which extend, for instance, in parallel to each other, the peripheral surface of the narrow side of the housing 2, i.e. the wall being identified by 2e. The returning backing tape portion 7b extends towards a take up device 12 mounted in the cavity of the housing 2 wherein the take up device 12 can be a take up reel 13 which is rotatably mounted in the housing 2. The supply 9, too, can be formed by a reel, namely a supply reel 14 which is rotatably mounted in the housing 2. In the preferred embodiment, the supply 9 and the take up device 12 are arranged behind one another, the take up device 12 being disposed between the supply 9 and the working end 3 of the housing.

In the position of operation according to FIG. 1, the tip 4 abuts on the working surface 8 with its application edge 4b, wherein the central axis 4c of the central application gib 4a encloses an acute angle W1 with the correction surface 8 extending, for instance to be straight, the angle ranging, for example, between approximately 30° to 60°. By moving the hand-held device 1 in the application direction identified by 15, the backing tape section 7a is peeled off the supply 9 due to the friction at the correction surface 8. In doing so, the deposit 5 remains on the correction surface 8, and the backing tape section 7b is moved into the cavity of the housing 2, here to the take up device 12. The backing tape section 7b is driven by the backing tape section 7a approaching the tip or its tensile force. In the present preferred embodiment, this is effective by providing a swivel drive connection 16 between the supply reel 14 and the take up reel 13, for instance, in the form of overlapping rubbing surfaces 17a, 17b at the peripheral edges of the walls of the reels. The winding diameter of the reels 13, 14 is dimensioned to be large enough for the take up spool 13 to attempt to pull in the support paper 7, also in the event of full supply reel 14, at a speed which is higher than the speed at which the support paper 7 is wound off by the supply reel 14. By a clutch 18 integrated in the swivel drive connection 16, which here is formed by the rubbing surfaces 17a, 17b which are in frictional contact with one another, it is ensured that the take up reel 13 pulls in the support paper always at a certain tensile stress, whereby the formation of loops in the support paper 7 is avoided. The application direction 15 is directed to the end of the housing 2 opposite the working end 3.

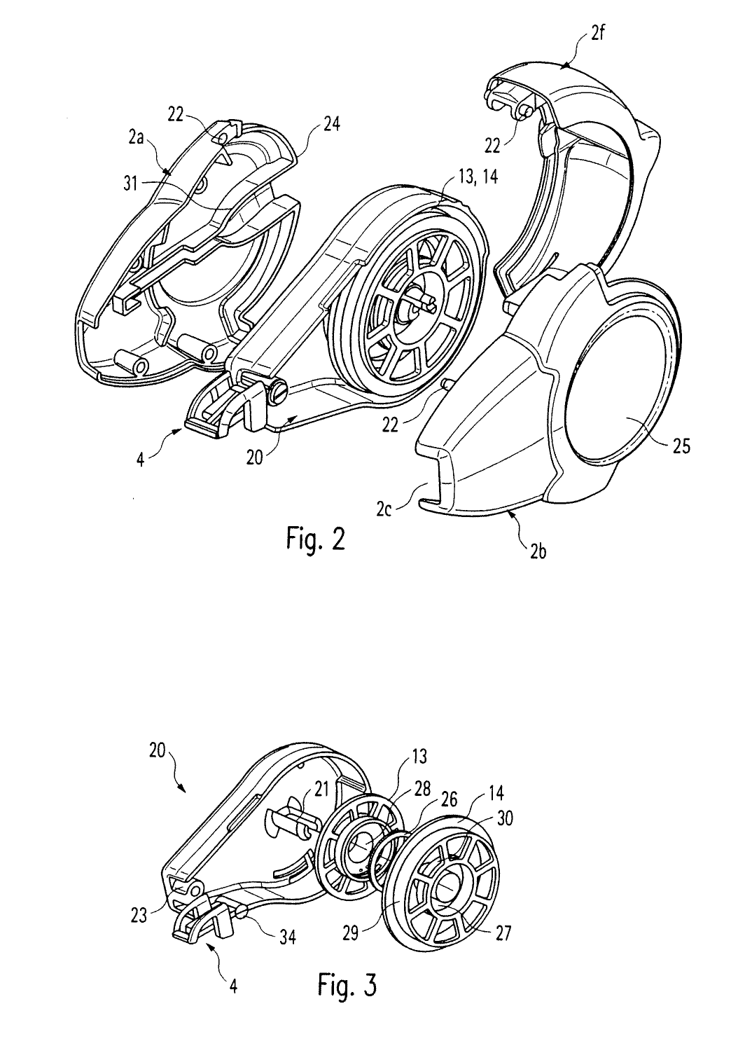

With reference to FIG. 2 a second embodiment of a hand-held device 1 according to the present invention will be explained. The housing 2 hereby comprises at least three housing parts, namely an upper body 2a, a lower body 2b and a rear body 2f. The upper body 2a and the lower body 2b, as in the first embodiment are longitudinally or transversely divided housing parts which can be mounted to each other. The rear body 2f can be mounted to the rear side of the housing 2 opposite the working end 3. The housing parts 2a, 2b, 2f can be mounted to each other in a detachable or non-detachable fashion.

For mounting the housing parts 2a, 2b, 2f to each other body fixation means 22 are provided. These body fixation means 22 comprise body fixation pins adapted to interact with body fixation nuts, i.e. adapted to be inserted into the body fixation nuts.

On one or two sides 2d of the housing 2, a grip trough 25 may be provided having a different surface than the rest of the housing 2b in order to simplify the holding and gripping of the housing 2. For example, the grip trough 25 may be a roughened surface or may comprise grip ribs.

In the specific embodiment, the supply reel 14 and the take up reel 13 are mounted onto one common single center axle 21. The tape 7 as described in the first embodiment is guided from the supply reel 14 along the lower longitudinal side 11a to the tip 4 and then along the upper longitudinal side 11b to the take up reel 13.

The center axle 21 can be directly attached to one of the housing parts 2a, 2b as shown in the first embodiment or a separate cartridge 20 can be provided housing a supply reel 14, the take up reel 13 and the tip 4. This cartridge 20 can be attached in a fixed manner to the housing 2 or the housing 2 as shown in FIG. 2 may provide a guiding rail 31, which enables the cartridge to be moved along the direction of the guiding rail 31, i.e. in the present embodiment along a direction parallel to the central axis 4c either from the working end 3 to the rear end device or vice versa. Further, in case the deposit 5 of the tape 7 has terminated, instead of throwing the whole hand-held device 1 away, the cartridge 20 can be changed and the housing 2 can be kept. Specifically, for changing the cartridge 20, the rear body 2f of the housing can be removed and the cartridge 20 can be guided along the guiding rail 31 in a direction away from the working end 3 and can be removed at the rear side of the housing 2. A new cartridge 20 can then be inserted from the rear part of the housing, guided along the guiding rail 31 in direction of the working end 3 and the rear body 2f of the housing 2 can then be reattached.

FIG. 3 shows an exploded view of the cartridge as explained with respect to FIG. 2. Attached to the cartridge 20 is the center axle 21 supporting the supply reel 14 as well as the take up reel 13. The supply reel 14 comprises an axle bore 27 and the take up reel 13 comprises an axle sleeve bore 28 enabling the mounting of the supply reel 14 and the take up reel 13 onto the center axle 21. The take up reel 13 and the supply reel 14 are adapted to engage with each other. Additionally, an O-ring 26 is provided to couple the supply reel 14 to the take up reel 13. A clutch mechanism as provided in the first embodiment can further be provided. Preferably, the supply reel 14 comprises a clutch contact ring 30 adapted to engage with the clutch mechanism.

The tip 4 can be mounted detachable or non detachable to the cartridge 20. Preferably, attached to the application base 6 of the tip 4 a cylindrical tip holder 34 is provided which is adapted to engage with a tip fixation pin 23 attached to the cartridge 20 or the housing 2.

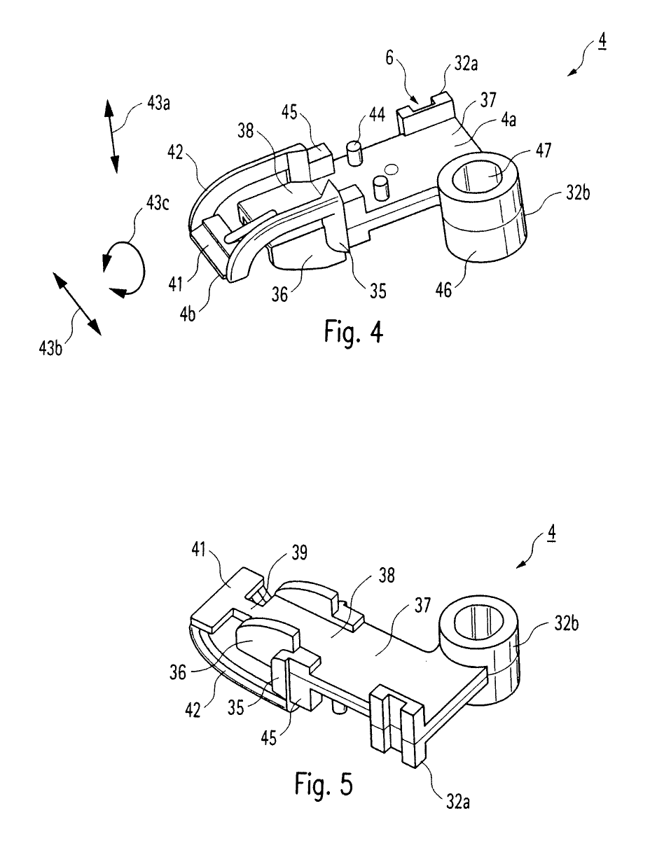

The embodiment of a cartridge 20 comprising the supply reel 14, the take up reel 13 and the tip 4 can also be provided in the first embodiment as shown in FIG. 1, i.e. the supply reel 14 and the take up reel 13 can also be mounted on different axles within the cartridge 20. With reference to FIGS. 4 to 8 the specific embodiment of the tip 4 according to the present invention in the following will be explained in detail. The hand-held device according to the present invention is a side dispenser, i.e. the planes of rotation of the take up reel 13 and the supply reel 14 run in parallel with the application edge. The hand-held device shown in FIGS. 1 to 3 can be used with any type of tip 4.

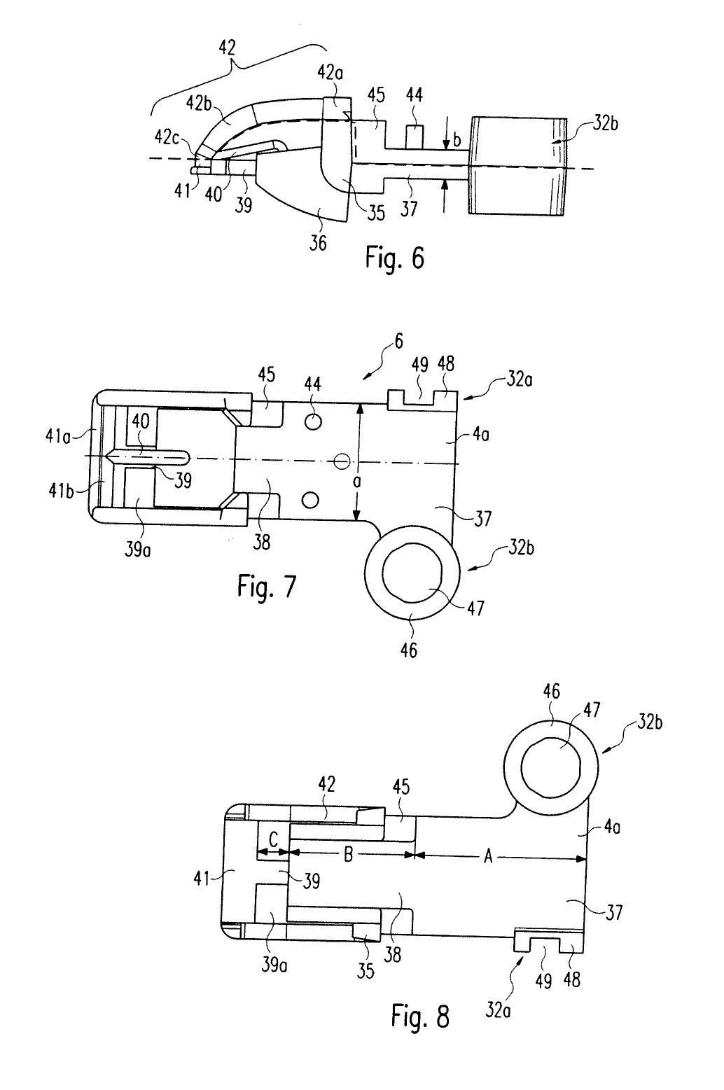

FIG. 4 is a perspective top view of a tip according to an embodiment of the present invention. FIG. 5 is a perspective bottom view of a tip according to an embodiment of the present invention, FIG. 6 is a side view of a tip according to an embodiment of the present invention, FIG. 7 is a top view of a tip according to an embodiment of the present invention, and FIG. 8 is bottom view of a tip according to an embodiment of the present invention. Parts being filled with lines hereby represent a cross-sectional view of the respective part.

The tip 4 includes a central application gib 4a, a front tip portion 41, tip holders 32, and guiding wings 35, 36, 42, 45. The central application gib 4a functions as a base to which the other components of the tip 4 are attached. The front tip portion 41 is attached to and supported by the central application gib 4a. The tip holders 32 are preferably attached to the base 6 of the central application gib 4a and enable the mounting of the tip 4 to either the housing 2 or the cartridge 20. In addition, one or several types of guiding wings can be provided in order to constitute a guide for the tape 7 and/or support the tip 4.

In the preferred embodiment the central application gib 4a has a flat cross sectional shape whose width is preferably a multiple of its thickness b i.e. a ratio of about 3:1 to 10:1, in particular about 6:1. Due to this cross-sectional shape, the central application gib 4a has a relatively high horizontal moment of resistance and a relatively low vertically moment of resistance. As a result thereof, the central application gib 4a tends to evade from the application pressure 19 arising during the mode of operation by bending upwards. In order to prevent this and to guide the tape 7, guiding wings 35, 36, 42 are provided on top and at the bottom of the central application gib 4a between which guiding wings the tape 7 is guided with freedom of play and which constitute a guide for the tape 7. Specifically, the front tip portion 41 is elastically bendable in a vertical direction under the effect of the application pressure 19 and is automatically bent back by the elastic restoring force generated when it is bent outwards, as soon as the application pressure 19 is ineffective. Thus, the front tip portion 41 is cushioned against hard pressure loads in its vertical plane.

In order to ensure for the front tip portion 41 degrees of freedom 43a to 43c illustrated by double arrows in the figures, the central application gib 4a has a cross-sectional reduction 39 in the form of a slot or a cross-sectional reduction 39a extending at right angles to the central axis 4c, which reduces the cross-sectional size of the central application gib 4a to a preferably mid centrally arranged remaining cross section and thus diminishes the strength of the application gib 4a such that the front tip portion 41, which is in front with respect to the cross-sectional reduction, can carry out movement relative to the central application gib 4a.

In the preferred embodiment a central application gib 4a comprises three parts. At the rear end of the central application gib 4a, i.e. at the end away from the working end 3, an end part 37 of the central application gib is provided. In front of the end part 37 a middle part 38 is provided, the end part 37 and the middle part 38 hereby may slightly differ in their width a and/or in their thickness b. Specifically, the thickness b of the middle part 38 may be slightly tapering towards the front end of the central application gib 4a. In the preferred embodiment, however, the width of the middle part 38 is smaller than the width of the end part 37 and the middle part 38 and the end part 37 have the same height a. The length A of the end parts 37 and the length B of the middle part 38 may be equal or may differ. The central application gib 4a further comprises a narrow part 39 provided in front of the middle part 38. The narrow part 39 preferably has a reduced cross-section, i.e. the width a of the narrow part is significantly smaller than the width a of the middle or of the end parts 37, 38. Additionally, the thickness b of the narrow part may also be decreasing in direction of the front tip portion 41. The length C of the narrow part is preferably smaller than the length A, B of the end and middle part 37, 38.

In the area of the narrow part 39, the moment of resistance of the central application gib 4a is reduced, whereby due to the elasticity of the central application gib 4a prevailing in the area of the remaining cross-section, the front tip portion 41 is moveable relative to the central application gib 4a from its normal rest position and automatically returns into its original position due to the elasticity of material in the range of the narrow part 39. The cross-sectional reduction on top and/or at the bottom affords swivelling of the front tip portion 41 relative to the central application gib 4a in a vertical direction. The first degree of freedom is identified by 43a. Due to the narrow part 39, which leaves a cross-sectional reduction 39a on both sides of the central application gib 4a, the front tip portion 41 is laterally bendable with respect to the central application gib 4a in a horizontal direction against the prevailing elastic restoring force as shown by 43b. If the material reduction is present on all sides, the front tip portion 41 is pivotal relative to the central application gib 4a both vertically and horizontally and is also torsional about the central axis 4c of the remaining cross-section, namely also against the elastic restoring force of the narrow part 39, so that, in the absence of a load causing the torsion, the front tip portion 41 is automatically returned into its mid-central original position. Due to this elastic suspension of the front tip portion 41, the latter is in a position, during the mode of operation of the hand-held device 1, to adapt to different lateral inclinations of the correction surface 8, without a person using the hand-held device 1 having to pay special attention to the different inclinations. Thereby, it is not only the pressure of the front tip portion 41 against the correction surface 8, especially its pressure over the surface, that is improved or a pressure over the surface is ensured also in the event of different inclinations of the substrate surface, but also the handling of the hand-held device 1 during the mode of operation is facilitated. The horizontal degree of freedom is identified by 43b, and the degree of torsion freedom by 43c.

In order to border the movement of the front tip portion 41, to provide a guiding for the tape 7 and/or to reinforce some parts of the tip 4 in order to prevent damage or breaking, several additional parts are provided on the tip 4.

On the upper part and/or on the lower part of the narrow part 39 of the central application gib 4a, i.e. either on the approach side 7a of the tape 7 and/or on the return side 7b of the tape 7 a bead 40 can be provided. In the preferred embodiment this bead is extending in longitudinal direction, i.e. in parallel to the central axis 4c and is provided in the middle of the narrow part 39. The longitudinal extension of the bead 40 in the preferred embodiment is larger than the longitudinal extension C of the narrow part 39, that means that the bead also extends partly over the front tip portion 41 and over the middle part 38. The width of the bead is preferably smaller than the width a of the narrow part 39. With the bead the narrow part 39 is strengthened and it is further ensured that the narrow part 39 can not be easily detached from the middle part 38 or from the front tip portion 41. Additionally, the bead 40 serves as a guide for the tape 7 which thereby enables the tape 7 to smoothly approach the application edge 4b and return back into the housing.

Laterally attached to the central application gib 4a are lateral guiding wings 35 which extend in parallel to the tip opening 2c of the housing 2. Between the lateral guiding wings 35 and the opening 2c of housing, rear lateral guiding wings 45 are provided, which are attached to the lateral sides of the central application gib 4a. The rear lateral guiding wings' 45 width and height are preferably smaller than the lateral guiding wings 35. The rear lateral guiding wings 45 preferably protrude the top as well as the bottom of the central application gib 4a. In the preferred embodiment the part of the rear lateral guiding wings 45 protruding the top part of the central application gib 4a is smaller than the part of rear lateral guiding wings 45 protruding the bottom part of the central application gib 4a. The rear lateral guiding wings 45 have an essentially cuboidal shape. The front part of the rear lateral guiding wings 45 preferably flushes with the rear part of the lateral guiding wings 35 and the rear part of the rear lateral guiding wings 45 is preferably substantially parallel to the opening 2c of the housing 2. Between the part of the rear lateral guiding wings 45 being parallel to the tip opening 2c of the housing and housing 2, a free space being constant in size is provided. In the preferred embodiment the lateral guiding wings 35 project from the top surface of the central application gib 4a as well as from the bottom surface of the central application gib 4a. The lateral guiding wings 35 thereby on the approach side 7a as well as on the return side 7b of the tape 7 provide a guide for the tape. The lateral guiding wings 35 preferably have a square cross-section.

Alternatively, on the bottom side of the central application gib 4a i.e. on the approach side 7a of the tape 7 additional lower guiding wings 36 can be provided. In the preferred embodiment these lower guiding wings 36 have a length extending from the lateral guiding wings 35 to the front end of the middle part 38 of the central application gib 4a. The height of the lower guiding wings 36 in a curved shape is tapering towards the front end of the middle part 38 of the central application gib 4a. In the preferred embodiment the rear part of the lower guiding wings 36 flushes with the part of the lateral guiding wings 35 that protrudes the bottom surface of the central application gib 4a.

As already explained, the front tip portion 41 is attached to and supported by the narrow part 39 of the central application gib 4a. Additionally, the front tip portion 41 may be supported by the bead 40. According to an embodiment of the present invention, partially curved guiding wings 42 are additionally provided. These partially curved guiding wings 42 extend from the top portion of the lateral guiding wings 35 in a partially curved manner until a front tip portion 41. The partially curved guiding wings 42 comprise a first straight part 42a which is attached to the top portion of the lateral guiding wings 35. The partially curved guiding wings 42 include a curved part 42b which extends towards the front tip portion 41. Preferably, the partially curved guiding wings 42 with the curve parts 42b may directly end at the front tip portion or a second straight part 42c can be provided connecting the curve part 42b and the front tip portion 41. With these partially curved guiding wings 42 the front tip portion 41 is further supported so that a possible damage or breaking of either the front tip portion 41 or the narrow part 39 is prevented. On the other hand, the partially curved guiding wings 42 provide enough mobility of the front tip portion 41 to still enable the front tip portion 41 to move in the direction of all grades of freedom 43a, 43b, 43c. Since the partially curved guiding wings are in the form of a bend and are not covering the whole side of the central application gib 4a, they provide support and great flexibility at the same time. The partially curved guiding wings additionally provide a guide for the tape 7 on the return side 7b and prevent slippage of the tape 7 off the tip 4. Specifically, in case no lower guiding wings 36 are provided a guide for the tape 7 at least on one side of the tip 4 is preferable.

Since the partially curved guiding wings are not covering the whole side of the central application gib but are provided as a band extending from the lateral guiding wing to the front tip portion 41 material can be saved which is specifically important for the production of such a tip 4. With the partially curved guiding wings therefore the production costs can be reduced and at the same time the functionality of the tip is not negatively influenced, since the front tip portion still is able to move into all directions but at the same time is additionally supported thereby preventing braking or the like.

Additional tape guiding pins 44 are preferably provided on the top of the central application gib 4a for guiding the tape 7 from the front tip portion 41 back to the take up reel 13.

In order to further reinforce the front tip portion 41 on the front tip portion base 41a a front tip portion bead 41b can be provided having the same width as the front tip portion base 41a and a reduced length, i.e. a reduced extension in direction of the central axis 4c. In case a front tip portion bead 41b is provided then the bead 40 extends also partly over the front tip portion bead 41b.

On the base 6 and preferably on the end part 37 of the central application gib 4a tip holders 32a, 32b on each side of the central application gib 4a are provided in order to enable the mounting of the tip 4 onto the housing 2. In the preferred embodiment two lateral plug-in recesses 47, 49 are formed at the central application gib 4a or lateral material lugs 46, 48. The one plug-in recess 47 is formed by a plug-in hole in formed jack 46 in the preferred embodiment. The other plug-in recess 49 is formed by a laterally open groove in the appertaining material lug 48. The latter is positioned between two housing halves in a form-fit fashion in a direction transversely to the longitudinal plane of the tip 4 containing the application edge 4b.

In the preferred embodiment, the tip is designed so as to be suitable for a hand-held device 1 in which the planes of rotation of the take up reel 13 and the supply reel 14 run in parallel with the application edge 4b. That is to say that in the preferred embodiments the tip 4 with its application edge 4b is arranged to be distorted by 90° with respect to the central axis 4c. The user during application therefore has to hold the hand-held device 1 in a flat position. The hand-held device 1 according to an embodiment of the present invention is preferably a side dispenser.

The housing 2 or the housing parts 2a, 2b, 2f, the reel 13, 14 and the tip 4 are preferably injection moulded parts, especially made of plastic material, which ensures simple and inexpensive manufacture also in case of complicated shapes.

1-9. (canceled)

10. A hand-held device for transferring material onto a surface comprising:
a housing that includes a supply reel for supplying the material;
a tip longitudinally projecting from the housing with the material extending from the supply reel at a lower longitudinal side of the tip facing the surface during operation to a front tip portion of the tip running transversely at a front end of the tip,
wherein a rotation plane of the supply reel is substantially parallel to the front tip portion,
wherein the tip includes at least one partially curved guide wing attached to the front tip portion.

11. The device according to claim 10, wherein the front tip portion is attached to a central application gib extending along the tip.

12. The device according to claim 11, wherein a lateral guide wing is laterally attached to the central application gib.

13. The device according to claim 12, wherein the lateral guide wing is a cuboid protruding from the top and the bottom of the central application gib.

14. The device according to claim 12, wherein the partially curved guide wing extends from the lateral guide wing to the front tip portion.

15. The device according to claim 10, wherein the partially curved guide wing is a band having a substantially circular cross-section.

16. The device according to claim 12 wherein the partially curved guide wing comprises a first straight part attached to the lateral guide wing.

17. The device according to claim 16 wherein the partially curved guide wing comprises a curved part extending from the first straight part to the front tip portion.

18. The device according to claim 16, wherein the partially curved guide wing includes a curved part attached to the first straight part and to a second straight part, the second straight part extending to the front tip portion.

19. The device according to claim 10 wherein the partially curved guide wing is provided on an upper longitudinal side opposite the lower longitudinal side of the tip.

20. The device according to claim 12, wherein on each side of the central application gib the partially curved guide wing and the lateral guide wing are provided.
